(19) United States
(12) Patent Application Publication
(10) Pub. No.: US 2016/0198678 A1
(43) Pub. Date: Jul. 14, 2016

(54) TIMED DEER FEEDER WITH RESTRICTED ACCESS

(71) Applicant: BNR Technology Development LLC, Conroe, TX (US)

(72) Inventor: Jeffrey B. Norris, Montgomery, TX (US)

(21) Appl. No.: 14/596,788

(22) Filed: Jan. 14, 2015

(51) Int. Cl. A01K 5/02

(52) U.S. Cl. CPC A01K 5/0291; A01K 5/02

(57) ABSTRACT

An animal feed dispenser includes a feeding tube for receiving a predetermined amount of animal feed from a spinner disk located at the bottom of an outlet in a housing. The feeding tube includes at least one opening through which animals may access the interior of the feeding tube. The opening may be closed by a movable closure flap so as to restrict access to the feeding tube. The motor for rotating the spinner disk and an actuator for moving the closure flap may be controlled by a suitable timer mechanism.

This application is a continuation application of Ser. No. 13/751,478 filed on Jan. 28, 2013.

### BACKGROUND OF INVENTION

1. Field of the Invention

This invention relates to apparatus for periodically dispensing a controlled amount of animal feed. One application of the apparatus is to dispense a controlled amount of deer feed in remote areas so as to lure game to a particular location for hunting purposes.

2. Description of Related Art

There are several devices in use for dispensing animal feed in remote locations. However, several of them suffer from the following characteristics. Many are of the scattering type which dispenses the feed over a project area on the ground. In this situation, a good portion of the feed is consumed by other than targeted animals. For example, if the hunted game is deer, many other types of animals such as wild hogs, squirrels, raccoons, etc. will consume the food. This results in an increase in the amount of feed that is broadcasted.

Other types include a tripod supported hopper with the scatterer and motor drive located beneath the hopper which interferes with the movement of animals underneath the apparatus. As deer, hogs and other animals feed, they damage the spreader or drive units by hitting the units with their horns, heads, or parts of their body, in some cases, chewing the wiring. Once damaged, they no longer function as designed. This problem is eliminated by placing all electrical and moving parts above the hopper.

### BRIEF SUMMARY OF THE INVENTION

The present invention cures the deficiencies noted above by providing a controlled supply of feed and dispensing it in such a way so as to allow access to the feed only to the targeted animal, in one embodiment a deer.

A dispensing disk feeds a controlled amount of feed to a tray-like feeder which is positioned above the ground at a distance such that only the targeted animals can access the food or the tray.

This significantly reduces the amount of food required to attract the deer which saves money and also reduces the frequency of filling the hopper with feed.

A timer may be provided to selectively activate the dispenser mechanism.

### BRIEF DESCRIPTION OF THE SEVERAL VIEWS OF THE DRAWING(S)

FIG. 1 is a perspective view of the deer feeder according to an embodiment of the invention.

FIG. 2 is a view of an embodiment of the invention showing the hopper and feeding assembly.

FIG. 3 is an exploded view of FIG. 2.

FIG. 4 is a cross-sectional view of the hopper and feeding assembly.

FIG. 5 is a schematic view of an alternative arrangement for the feeding tube and outlet.

### DETAILED DESCRIPTION OF THE INVENTION

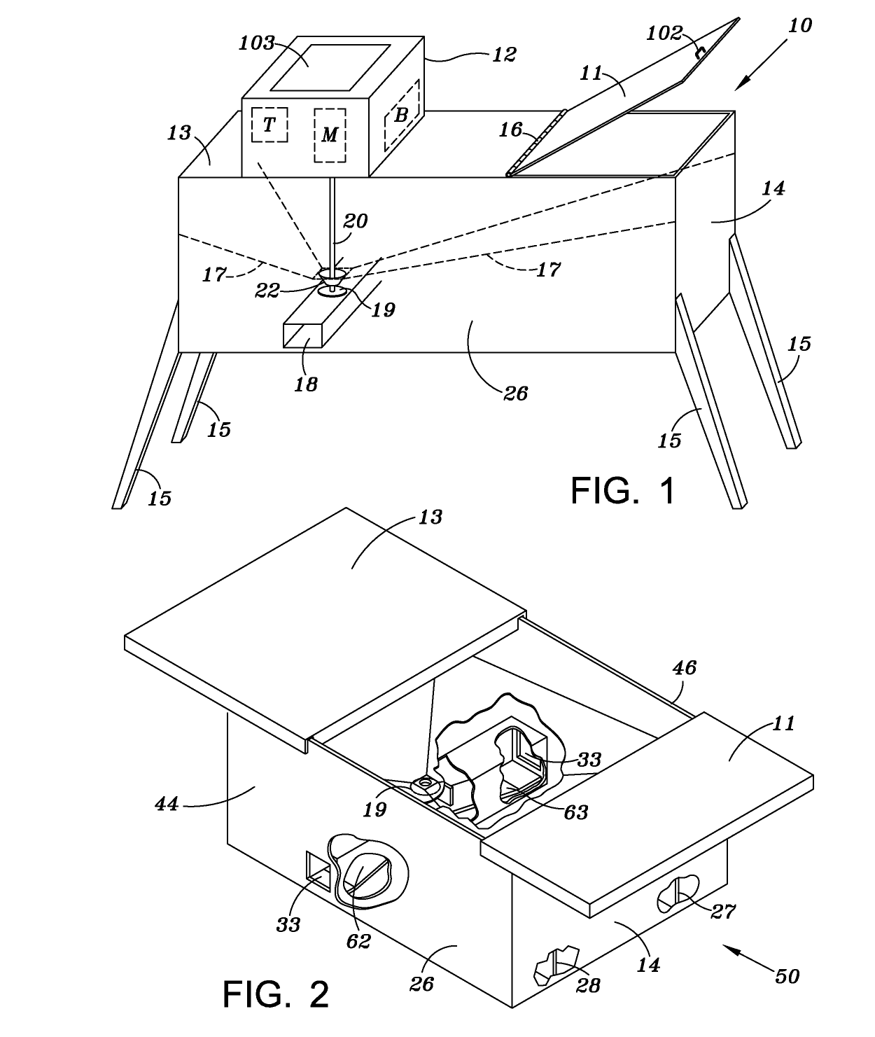

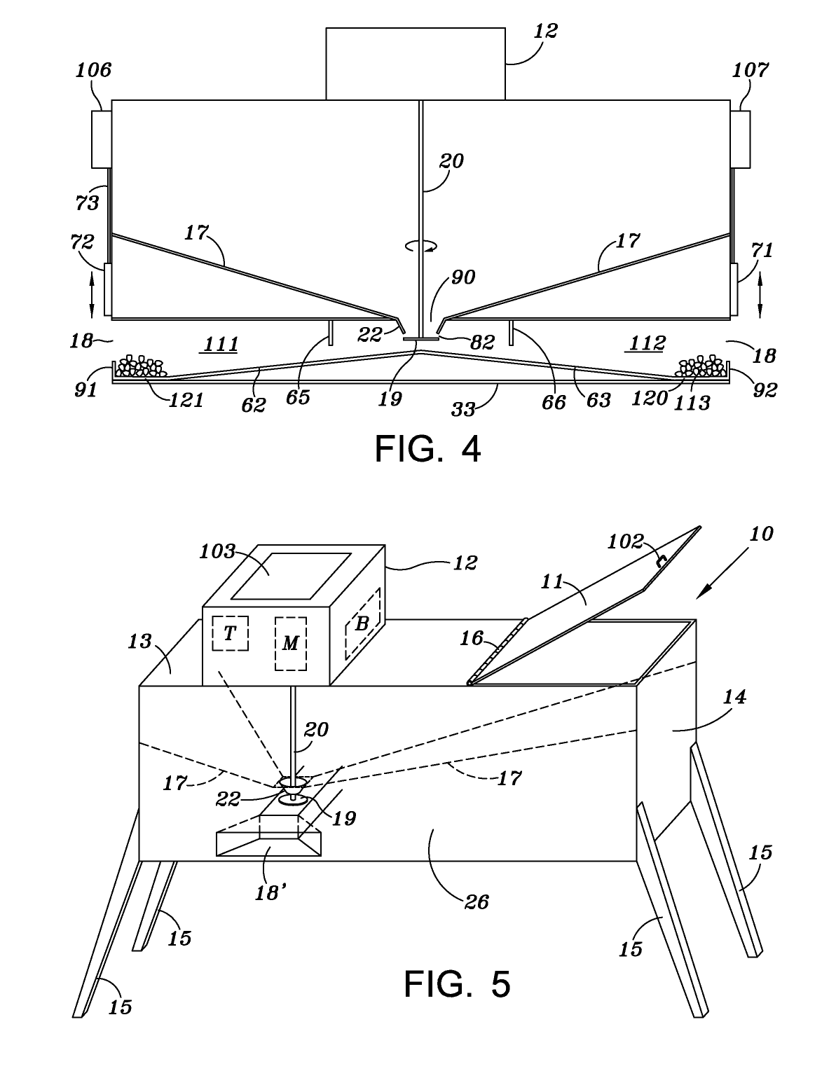

As shown in FIGS. 1 and 2, an embodiment of the deer feeder 10 according to the invention includes a generally rectangular shaped main housing or hopper 50 having front and rear panels 26 and 46 and side panels 9 and 14. The housing has a floor 17 which may include a plurality of downwardly sloping sections. An opening 90 is provided at the lowest point of floor 17. A hollow conical member 22 surrounds the opening and extends downwardly from the floor of the hopper as shown in FIG. 4.

The housing includes an upper first cover member 13 which supports a motor M, a timer mechanism T and a power source such as a battery B enclosed with housing 12. The power source may include a solar cell 103 on a top portion of the housing 12 for recharging the battery. A second cover member 11 is pivotally connected at 16 to the housing and includes a handle 102 for providing access to the interior of the housing. This arrangement allows for placement of suitable game feed within the housing 10. The housing further includes openings 18 located at a lower portion of the front and rear panels.

The housing 50 is supported by legs 15 at a height above the ground such that the targeted game, for example deer, is able to feed.

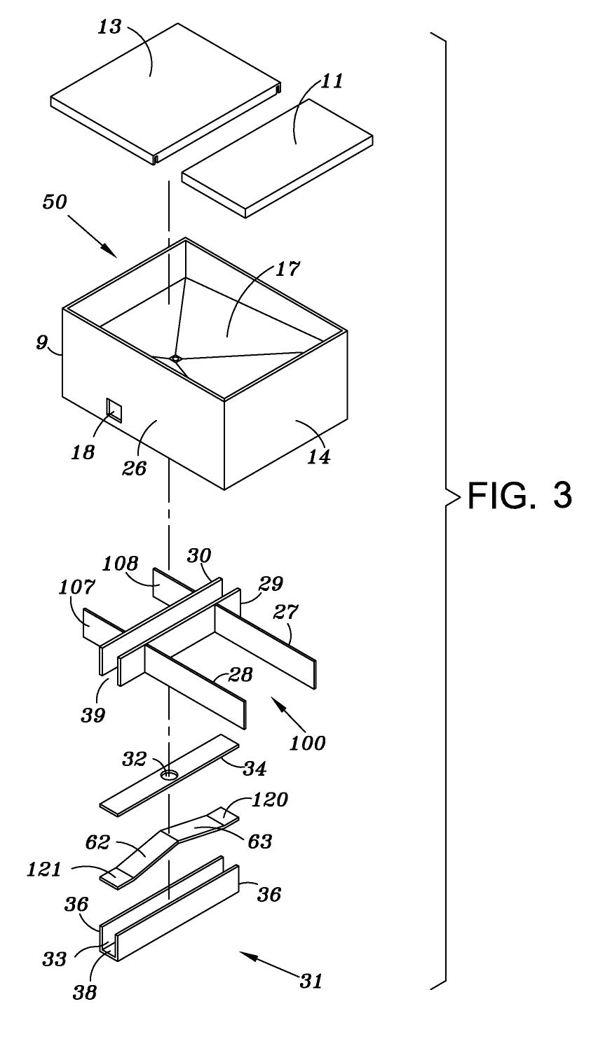

FIGS. 2 and 3 illustrate an example of a specific construction of the housing and feeding assembly. However it is understood that they represent only an example of the invention and many other arrangements are possible and would be evident to one with ordinary skill in the art.

In order to form a support 100 for a feeding assembly, a plurality of length wise support plates 107, 108, 28 and 27 are secured to sideway plates 29 and 30 in the manner shown in FIG. 3 and the support is the secured to the front, rear and side walls of the housing as shown in FIG. 2. This forms a generally rectangular channel 39.

The feeding assembly 37 shown in FIG. 3 comprises a rectangular feeding tube 31 having front and rear sections 36, a bottom portion 38 and a top portion 34 having an opening 32 through which a shaft 20, a spinner disc 19 and cone member 22 extend in a manner to be discussed below. Feeding tube 31 is secured within channel 39 in any known manner.

FIG. 4 illustrates the details of an embodiment of the dispensing assembly. A hollow cone 22 extends downwardly from opening 90 in the floor 17 of the housing. A spinner disc 19 secured to a shaft 20 is located slightly below the outlet of the cone and thereby forms an annular opening 82 through which animal feed may pass. The size of opening 82 is such that the animal feed will not pass through it until spinner disc 19 is rotated by shaft 20 which is connected to a motor in housing 12 in any known manner. Two baffles 65 and 66 extend downwardly from the top of feeding tube 31 such that animal feed that is thrown outwardly from spinner disc 19 will impinge on the baffles thereby being directed to downwardly inclined floor portions 62 and 63 of the feeding tube. Spinner disc 19 may include one or more blades on its top surface. The floor portion of the feeding tube 31 may also include horizontal sections 121 and 120 that form a retaining area for the feed 113.

Openings 18 in the front and rear walls of the housing are slightly smaller than the openings 33 of the feeding tube 31 such that a pair of upwardly extending tips 91 and 92 cooperate with sloping wall portions 62 and 63 to form a feeding tray at each end of the feeding assembly which will restrain a given amount of animal feed from being discharged through the outlets 18. A timer will selectively energize the motor that rotates spinner disc 19 for a given amount of time to fill the feeding tray and then will de-energize the motor so that a pre-selected amount of animal feed is retained in the feeding tray and no more. This significantly reduces the amount of feed that is required as compared to the prior art devices.

The deer feeder may include a bottom member which isolates the lower discharge assembly from the environment.

Outlet 18 may be widened so as to accommodate a plurality of animals to feed at one time. In such an arrangement the feeding tube could be modified by having the feeding assembly with feeding tubes 31 diverging outwardly toward the widened outlet 18′ as figuratively sown in FIG. 5. Support assembly 100 would also be modified to accommodate the diverging feed tube.

In order to restrict access to the feeder assembly, a closure mechanism, for example, flaps 71 and 72 may be positioned on the housing for selectively covering openings 18. The flaps may be mounted for reciprocal movement in tracks 73 as shown in FIG. 4 and may be moved up and down by any known reciprocating mechanism 106 and 107 for example, by a linear actuator, a rack and pinion mechanism, a crank arm or any other mechanical leakage for effecting reciprocal motion. Alternatively, the flaps may be pivotably mounted on the housing for movement outwardly from the housing by a suitable crank mechanism to uncover the opening. The actuating mechanism may include a motor that is synchronized with the spinner disc motor so that the flaps are in an open position for a limited time after the spinner disk has been actuated. The actuating mechanism motor may also be synchronized with the spinner disc motor to open the flaps for feeding during daytime hours and closed at night to prevent nocturnal feeding.

The apparatus as defined above may be utilized in the following manner. The deer feeder can be placed in the area where game is to be attracted. The openings 18 are positioned at a height above the ground so that only the desired game is able to access the feeding tray. A supply of game feed is placed within the housing and the timer for the spinner disc motor is set for a limited time during the day so that only a measured amount of feed is fed to the feeding trays formed in the dispensing assembly. Once the feed has been delivered to the feeding trays, flaps 71 and 72 can be raised upwardly by a timer mechanism so as to uncover opening 18 in the housing. At this point, game such as deer will be able to access feed in the feed trays until all the feed is exhausted. After a predetermined amount of time, a timer may act to lower the flaps so as to block access to openings 18. In addition, hunters can reasonably forecast how long the supply of food will last and when it needs to be replenished.

Although the present invention has been described with respect to specific details, it is not intended that such details should be regarded as limitations on the scope of the invention, except to the extent that they are included in the accompanying claims.

1. Apparatus for dispensing a controlled amount of animal feed from a hopper comprising:
a feeding tube having a downward inclined surface adapted to receive annual feed from the hopper;
the feeding tube including an opening to allow deer to access an interior of the feeding tube and to feed on the animal feed that has been dispensed onto the inclined surface of the feeding tube; and
a movable closure member blocking access to the interior of the feeding tube.

2. The apparatus of claim 1 further including a baffle positioned within the feeding tube to deflect the animal feed onto the inclined floor of the tray.

3. The apparatus of claim 1 wherein the feeding tube includes a rectangular elongated box having open ends, two included bottom surfaces that are inclined downwardly from a central portion of the box to the side portions, and a top having an opening in alignment with an outlet in the lower portion of the hopper.

4. Apparatus for feeding game animals comprising:
a housing for holding a supply of game feed;
an outlet in a bottom portion of the housing;
a metering device located below the outlet for receiving and dispensing animal feed;
a feeding tube positioned adjacent the metering device for receiving and retaining a given amount of animal feed;
the feeding tube having an opening for allowing an animal to access feed stored within the feeding tube; and
a closure means for the feeding tube opening for preventing access to an interior portion of the feeding tube.

5. The apparatus of claim 4 further including an upwardly extending lip positioned on the feeding tube at its outlet in order to retain a given amount of animal feed within the feeding tube.

6. The apparatus of claim 1 further including an upwardly extending lip positioned on the feeding tube at its outlet in order to retain a given amount of animal feed within the feeding tube.

7. Apparatus for dispensing a controlled amount of animal feed comprising:
a housing for holding the animal feed;
an outlet in a bottom portion of the housing;
one or feeding tubes that receive the animal feed, the feeding tube having an outlet for permitting animals to access feed located within the tube; and
means for opening and closing the feeding tube outlet to control access to feed located within the feeding tube.

8. The apparatus of claim 12 wherein the means for opening and closing the feeding tube outlet includes a flap, a motor connected to the flap to move it to an open and closed position, and a timer connected to the motor to selectively energize the motor to open and close the feeding tube outlet.

9. The apparatus of claim 12 further including a metering device located below the housing and a motor for rotating the spinner disc.

10. The apparatus of claim 1 wherein the feeding tube includes a horizontal portion that forms a feeding tray for retaining a portion of the animal feed.

11. A method for controlled access to animal feeding comprising:
providing a feeding tube having an inlet and an outlet for animal feed and a tray for supporting a given amount of animal feed within the feeding tube;
providing a flap for selectively opening and closing of the outlet of the feeding tube;
closing the feeding tube outlet during certain time periods for restricting access to the animal feed; and
opening the feeding tube outlet to allow access to the animal feed within the feeding tube during portions of the day when it is desired to attract animals to a given geographical area.

10. A method for controlled access to animal feed is claimed in claim 9 wherein the feeding tube includes a downwardly inclined surface so that the animal feed flows downward toward the feeding tube outlet by gravity along the inclined surface.
